(19) United States
(12) Patent Application Publication
(10) Pub. No.: US 2003/0152233 A1
(43) Pub. Date: Aug. 14, 2003

(54) Method of encryption

(76) Inventor: Ross Filippi, Bucks (GB)

Correspondence Address: NIXON & VANDERHYE, PC, 1100 N GLEBE ROAD, 8TH FLOOR, ARLINGTON, VA, 22201-4714, US

(21) Appl. No.: 10/351,359

(22) Filed: Jan. 27, 2003

Related U.S. Application Data
(63) Continuation-in-part of application No. PCT/EP01/08744, filed on Jul. 27, 2001.

(30) Foreign Application Priority Data
Jul. 27, 2000 (AU) PQ9041

(51) Int. Cl. H04L 9/00

(52) U.S. Cl. 380/277

(57) ABSTRACT

A method of data encryption including the steps of: obtaining a plurality of sub-keys from a secure long key; and generating an ecryption key from the sub-keys by; i) assigning a significance to each sub-key from most significant to least significant; ii) using bit values obtained from a given position of each sub-key to determine a bit of the encryption key; iii) rotating the bit values of the least significant sub-key; iv) repeating steps ii) and iii) a predetermined number of times and then rotating a next most significant sub-key, and v) repeating steps ii), iii) and iv) for one or more of the sub-keys in order of increasing significance.

### TECHNICAL FIELD

The present invention relates to the provision of secure communications by way of message encryption.

### BACKGROUND TO THE INVENTION

Message encryption is an extremely large field which is of increasing importance, due to the increase in traffic over telecommunications systems and particularly the internet, and the desire for providing secure communication of information over such systems. Where encryption is required in bi-directional communications between two parties, a symmetric encryption algorithm is typically used. A symmetric encryption algorithm is one where an encryption function E relies on a first key K₁, and a decryption function D relies on a second key K₂, where key K₂ can be derived from key K and key K₁ can be derived from key K₂.

Often K₁=K₂, however even when this is not the case, as each key can be derived from the other, the method of encrypting a message M to obtain data to be communicated C and vice versa can be defined with reference to a single key K:

EK[M]=C

DK[C]=M

An enormous variety of symmetric algorithms of this type exist, the security of which relies on the strength of the algorithms D and E and on the length of K. It has been suggested that 90 bits is an adequate key length, and most algorithms use a key length of around this order of magnitude.

One known algorithm is DES (Data Encryption Standard), an international standard, which uses a single key of length 56 bits. It has been shown that the DES algorithm is of limited security and that a brute-force attack with customised computers can obtain the key in as little as 3.5 minutes. Other known encryption algorithms include the Blowfish algorithm, which uses a variable length key of as little as 32 bits, the RC5 algorithm having a 128 bit key, and the IDEA algorithm, also using a 128 bit key.

The preceding description in no way constitutes an admission of the common general knowledge of a person skilled in this field.

### SUMMARY OF THE INVENTION

According to a first aspect the present invention provides a method of data encryption comprising the steps of:

obtaining a plurality of sub-keys from a secure long key;

and generating an encryption key from the sub-keys by:

i) assigning a significance to each sub-key from most significant to least significant;

ii) using bit values obtained from a given position of nominated sub-keys to determine a bit of the encryption key;

iii) rotating the bit values of the least significant sub-key;

iv) repeating steps ii) and iii) a predetermined number of times and then rotating a next most significant sub-key; and

v) repeating steps ii), iii) and iv) for one or more of the sub-keys in order of increasing significance.

According to a second aspect the present invention provides a method of data decryption comprising the steps of:

obtaining a plurality of sub-keys from a secure long key; and

generating a decryption key from the sub-keys by:

i) assigning a significance to each sub-key from most significant to least significant;

ii) using bit values obtained from a given position of nominated sub-keys to determine a bit of the decryption key;

iii) rotating the bit values of the least significant sub-key;

iv) repeating steps ii) and iii) a predetermined number of times and then rotating a next most significant sub-key; and

v) repeating steps ii), iii) and iv) for one or more of the sub-keys in order of increasing significance.

The secure long key is preferably significantly longer than 100 bits, and is currently envisaged as being a random or pseudo-random bit sequence of the order of 1 MB in length.

The given position of each sub-key may be the start or end of each sub-key, or any intermediate position. Further, the given position of one sub-key need not be the same as the given position of any other sub-key.

The sub-keys may be selected and operated in any manner from the secure long key, for example by the use of a configuration template. Each sub-key may be of varied length and may be taken from random positions of the secure long key. Moreover, the sub-keys may be taken from partially overlapping portions or even entirely overlapping portions of the secure long key, and may be taken from the secure long key in reverse bit order. Ideally, the selection of the sub-keys will be regularly changed, so that the encryption key or decryption key changes regularly.

The step of using bit values obtained from a given position of each sub-key to determine a bit of the encryption key may be performed by XOR-ing each of the bit values, or by any other method which determines a single bit result from the bit values.

The step of rotating the bit values of each sub-key may be performed in a variety of ways, such as shifting all bit values by one position, and moving an end bit value to the start of the sub-key, or by shifting all bit values by 2 or more positions and moving an appropriate number of end bit values to the start of the sub-key. The direction of rotation (or shifting) is not fixed and can be varied for each sub-key, e. g. according to information held in the configuration template. Moreover the variation, such as the direction and extent of rotation, for each sub-key can itself be controlled by the content of further sub-keys e. g. as defined by the configuration template.

The predetermined number of times may be equal to the number of bits in the sub-key of least significance. Similarly, step v) may be performed until the next most significant sub-key has been rotated a sufficient number of times to return to an original position. In this manner, the sub-keys are treated as ‘tumblers’, with one full rotation of a first sub-key causing rotation of the next most significant sub-key by one or more position (s). Steps iv) and v) of the method of the first aspect of the present invention may be repeated until an encryption key of desired length has been generated, or simply until all sub-keys have been rotated a sufficient number of times to return to an original position at least once. Similarly, steps iv) and v) of the method of the second aspect of the present invention may be repeated until a decryption key of desired length has been generated, or simply until all sub-keys have been rotated a sufficient number of times to return to an original position at least once.

The encryption key generated by the method of the first aspect of the present invention may then be used to encrypt a message to be sent, for example by XORing the encryption key with the message to be sent to produce an encrypted message. Similarly, the decryption key generated by the method of the second aspect of the present invention may be used to decrypt an encrypted message.

Even if an eavesdropper or attacker should obtain information relating to the manner of selection and operation of sub-keys from the secure long key, this information is useless without knowledge of the long key. Similarly, if the encryption key used for a given message should be determined, knowledge of that encryption key alone does not enable the attacker to determine the sub-keys, the secure long key or any other encryption key generated by the methods of the present invention.

In some embodiments of the methods of the first and second aspect of the invention, the secure long key may be generated by XOR-ing a plurality of secure base long keys. Embodiments of this type are advantageous in that, even if the security of one of the secure base long keys is compromised, the XOR action with other secure base long keys means that the secure long key itself is not compromised. This is the case provided the security of at least one of the secure base long keys is not compromised.

Evidently, both the source and destination of the encrypted message must use the same secure long key and the same manner of selection and operation of sub-keys. The manner of selection and operation of the sub-keys may be made known to both the source and the destination in a number of ways. For instance, information describing the manner of selection and operation of sub-keys may be communicated from the source to the destination along with the encrypted message. This information may itself be encrypted (in a manner known to the destination) or may be positioned at a predetermined position within the encrypted message. Even if this information is discovered by an attacker, if is useless without knowledge of the secure long key. Alternatively, the manner of selection and operation of sub-keys may be communicated from the source to the destination separately to communication of the encrypted message. Alternatively, the manner of selection and operation of sub-keys may change in accordance with a predetermined pattern of which both the destination and source are aware.

The method of the present invention has application in numerous environments, such as the encryption of transmissions over a public network or over an internal network such as a LAN, or a virtual LAN spread over a number of geographical sites such as is used by financial institutions.

The method of the present invention may also be used in real time encryption applications such as mobile telephone communications. For instance, the SIM card of a mobile telephone may be provided with a secure long key, and for each call conducted by the mobile telephone, a new encryption key may be generated in accordance with the method of the first aspect of the invention, and real-time encryption conducted throughout the call. Alternatively, the mobile telephone may be provided with a second SIM card having the secure long key. Further, the SIM card or the second SIM card may have a unique secure long key associated with each of a plurality of telephone numbers which are known to the mobile telephone, such that encrypted communication to one such number may only be decrypted by the party having the same unique secure long key.

The system embodying the invention may be located on, but not limited to, equipment such as routers, firewalls and telephone PABX devices.

The encryption and decryption processes could be in software on computer systems for the secure handling of files and data.

### BRIEF DESCRIPTION OF THE DRAWINGS

Embodiments of the invention will now be described by way of example with reference to the accompanying drawings in which:

FIG. 1 illustrates selection of sub-keys from a secure long key in accordance with the present invention;

FIGS. 2a and 2b illustrate generation of an encryption key from the subkeys;

FIG. 3 illustrates selection of sub-keys from a secure long key in accordance with a second embodiment of the present invention; and

FIG. 4 illustrates generation of an encryption key from the tumbling subkeys.

### DETAILED DESCRIPTION OF EMBODIMENTS OF THE INVENTION

For the purposes of the following discussion, a length of one bit will be used, but the length is not so limited and could in fact be a nibble (4 bits), a byte (8 bits) or any other value.

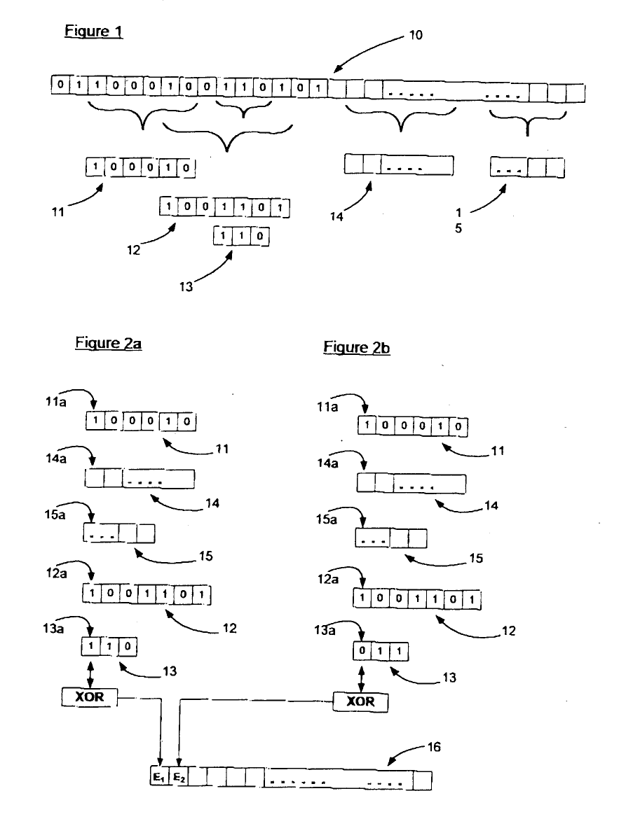

FIG. 1 of the accompanying drawings illustrates a method of encryption in accordance with the present invention. A secure long key 10, which ideally consists of a random or pseudo-random bit sequence, is held by both a source and a destination. Sub-keys 11,12,13,14 and 15 are selected from the secure long key 10. As can be seen, the sub-keys can be of any length greater than, less than or equal to the length of the secure long key 10, and may be chosen such as to partially overlap (11,12) or even completely overlap (12,13).

Following the selection of the sub-keys, an encryption key is generated by arranging the sub-keys in order from most significant to least significant. As can be seen in FIG. 2a, the significance of each sub-key can be assigned in any arbitrary manner. In this case sub-key 11 is the most significant, and sub-key 13 the least significant.

To determine the first bit Ei of the encryption key 16, the bit value in the start location of each sub-key (11a, 12a, 13a, 14a, 15a) is XOR-ed. To obtain subsequent bits (E2 etc), each sub-key is then treated as a ‘tumbler’. That is, the least significant sub-key 13 is rotated by one or more bit (s) such that the last bit of that sub-key becomes the first bit of that sub-key and all other bits are shifted by one or more place (s), as shown in FIG. 2b. Again, the bit value in the start location of each sub-key (11a, 12a, 13a, 14a, 15a) is XOR-ed, to produce a value for E2.

It will be appreciated that the location of the bit value which is XOR-ed at each step may be anywhere in each sub-key, however to simplify illustration, the start location is used in the present example.

The next rotation of sub-key 13 (not illustrated) and subsequent XOR function will produce a third bit for the encryption key 16, after which another rotation of the sub-key 13 will return each bit of sub-key 13 to an original position.

Hence, at this point, sub-key 12, being the next most significant sub-key, is rotated by a single bit, and then sub-key 13 is again rotated one bit at a time until returning again to the original position, and at each rotation one more bit of the encryption key 16 is generated by the XOR function. Rotation of the sub-keys continues in this manner until an encryption key of desired length has been generated or perhaps until all sub-keys have been rotated at least once to return to their original position, thereby exhausting all outcomes for an XOR operation on the start bit of those subkeys.

Finally, once the encryption key 16 has been generated by the above method, it is XOR-ed against a message to be sent, or otherwise used to encode the message.

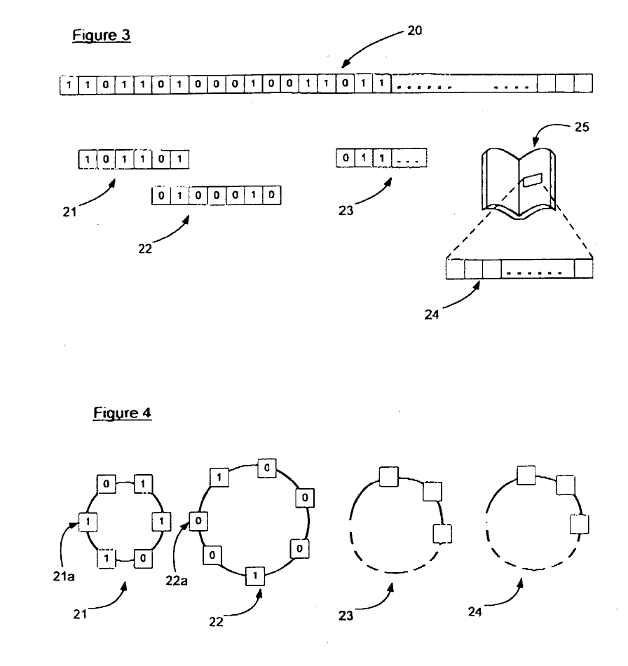

FIG. 3 illustrates a method of encryption in accordance with a second embodiment of the present invention. A secure long key 20, consisting of a random or pseudo random bit sequence, is known and held securely by both a source and a destination. Sub-keys 21, 22 and 23 are selected from the secure long key 20.

Selection of the sub-keys 21,22 and 23 from the secure long key 20 is performed in a manner which is known to both the source and destination. Further, an additional sub-key 24 is selected from a section of text from a book 25 in a manner which is known to both the source and destination. Sub-key 24 is digitised from the text of book 25.

Following the selection of the sub-keys, an encryption key is generated by arranging the sub-keys in order from most significant to least significant. As can be seen in FIG. 4, the significance of each sub-key in this embodiment is in the order of, from most significant to least significant, 21,22,23 and finally 24.

To determine a bit of the encryption key, the bit value in a start location of each sub-key (21a, 22a, etc) is XOR-ed or otherwise used to determine a single bit of the encryption key. To obtain subsequent bits of the encryption key, each of the sub-keys (21,22,23,24) is then treated as a tumbler as illustrated in FIG. 4. The least significant sub-key (24) is rotated by a single bit after which the bit value in the start location of each sub-key (21a, 22a, etc) is again XOR-ed or otherwise used to obtain a bit of the encryption key. Subsequently, tumbler 24 continues rotation until it has returned to an original position, after which the sub-key (or tumbler) of next most significance (23) is rotated by a single bit. Rotation of the sub-keys continues in this matter until an encryption key of desired length has been generated, or alternatively, until all sub-keys have been rotated at least once to return to their original position, thereby exhausting all outcomes for an XOR or other operation on the start bit of each sub-key.

Following generation of the encryption key in this manner, it may then be used to encrypt a message to be sent.

Corresponding generation of a decryption key at a destination permits decryption of the encoded message.

It will be appreciated by persons skilled in the art that numerous variations and/or modifications may be made to the invention as shown in the specific embodiments without departing from the scope of the invention as broadly I described. The present embodiments are, therefore, to be considered in all respects as illustrative and not restrictive.

For example, by the use of a configuration template generated for each message and stored temporarily in RAM for both encryption and decryption, the sub-keys are selected from the long key (s) and are operated so as to provide the bit values of the encryption or decryption key. Thus the data in the configuration template determines the way the sub-keys are taken. Moreover, the direction of rotation (or shifting) is not fixed and can be varied for each sub-key, according to the data held in the configuration template. Also, a variation, such as the direction and extent of rotation, for each sub-key can itself be set by the content of further subkey (s) defined by the configuration template.

1. A method of data encryption comprising the steps of:
obtaining a plurality of sub-keys from a secure long key; and
generating an encryption key from the sub-keys by:
i) assigning a significance to each sub-key from most significant to least significant;
ii) using bit values obtained from a given position of nominated sub-keys to determine a bit of the encryption key;
iii) rotating the bit values of the least significant sub-key;
iv) repeating steps ii) and iii) a predetermined number of times and then rotating a next most significant sub-key; and
v) repeating steps ii), iii) and iv) for one or more of the sub-keys in order of increasing significance.

2. A method of data decryption comprising the steps of:
obtaining a plurality of sub-keys from a secure long key; and
generating a decryption key from the sub-keys by:
i) assigning a significance to each sub-key from most significant to least significant;
ii) using bit values obtained from a given position of nominated sub-keys to determine a bit of the decryption key;
iii) rotating the bit values of the least significant sub-key;
iv) repeating steps ii) and iii) a predetermined number of times and then rotating a next most significant sub-key; and
v) repeating steps ii), iii) and iv) for one or more of the sub-keys in order of increasing significance.

3. A method according to claim 1, in which the secure long key is a random or pseudo-random bit sequence of the order of 1 MB in length.

4. A method according to claim 1, in which the given position of each sub-key is the start or end of each sub-key.

5. A method according to claim 1, comprising using a configuration template to select and operate the sub-keys.

6. A method according to claim 5, comprising using the configuration template to determine the direction of rotation for each sub-key.

7. A method according to claim 5, comprising using configuration template to determine the extent of rotation for each sub-key.

8. A method according to claim 6, further comprising using the content of one or more sub-key(s) defined by the configuration template to determine the direction of rotation.

9. A method according to claim 7, comprising using the content of one or more sub-key(s) defined by the configuration template to determine the extent of rotation.

10. A method according to claim 1, further comprising performing steps (iv) and (v) until an encryption key of desired length has been generated, or until all sub-keys have been rotated a sufficient number of times to return to an original position at least once.

11. A computer program for carrying out the method according to claim 1.

12. Data processing apparatus arranged to carry out the method of claim 1.

13. A method according to claim 1, wherein each sub-key is variable in length.

14. A method according to claim 1, wherein each sub-key is taken from random positions of the secure long key.

15. A method according to claim 1, wherein the sub-keys are taken from partially overlapping portions or entirely overlapping portions of the secure long key.

16. A method according to claim 1, wherein the sub-keys are taken from the secure long key in reverse order.

17. A method according to claim 1, wherein the sub-keys are derived from any other random source, such as a passage from a book.

18. A method according to claim 1, wherein the step of using bit values obtained from a given position of each sub-key to determine a bit of the encryption key is performed by an operation on each of the bit values.

19. A method according to claim 1, wherein the secure long key may be generated by performing an operation on a plurality of secure base long keys.

20. A method according to claim 5, wherein the manner of selection and operation of the sub-keys is made known to both the source and the destination in a variety of ways, such as communicating information describing the manner of selection and operation of the sub-keys from the source to the destination along with the encrypted message.

21. A method according to claim 20, wherein the information is encrypted in a manner known to the destination or positioned at a predetermined position within the encrypted message.

22. A method according to claim 20, wherein the manner of selection and operation of the sub-keys is communicated from the source to the destination separately to communication of the encrypted message.

23. A method according to claim 20, wherein the manner of selection and operation of the sub-keys changes in accordance with a predetermined pattern of which both destination and source are aware.

24. A method according to claim 1, wherein the bit values are grouped as any one of a nibble, a byte or any other value.

25. A method according to claim 6, wherein the direction of rotation of each sub-key is controlled by the content of further sub-keys, for example as defined by the configuration template.

26. A method according to claim 7, wherein the extent of rotation of each sub-key is controlled by the content of further sub-keys, for example as defined by the configuration template.
